(19) United States
(12) Patent Application Publication
(10) Pub. No.: US 2025/0147511 A1
(43) Pub. Date: May 8, 2025

(54) PATROL AND INSPECTION VEHICLE

(71) Applicant: Droxo Technology Co., Ltd., Tainan City (TW)

(72) Inventors: YI HUANG, Tainan City (TW); CHENG-HAN HSIEH, Tainan City (TW); CHUN-LIN LIU, Tainan City (TW); CHENG-HUNG SHIH, Tainan City (TW)

(73) Assignee: Droxo Technology Co., Ltd., Tainan City (TW)

(21) Appl. No.: 18/387,507

(22) Filed: Nov. 7, 2023

(51) Int. Cl. G05D 1/02

(52) U.S. Cl. CPC G05D 1/0248

(57) ABSTRACT

A patrol and inspection vehicle includes a vehicle body, distance measuring devices installed on front and rear sides of the vehicle body for detecting distances of ambient objects, a LiDAR sensor installed on the vehicle body for constructing a three-dimensional spatial model for positioning and navigation, a panoramic camera installed on the vehicle body for recognizing images of ambient individuals, and a gas detector installed on the vehicle body for detecting leaked gases having a temperature different from room temperature. The patrol and inspection vehicle can automatically inspect whether there are gas leaks in pipelines and detect if individuals have accidentally entered restricted areas, thereby reducing the manpower required for patrols and enhancing factory safety.

### BACKGROUND OF THE INVENTION

### 1. Field of the Invention

The present invention relates generally to autonomous vehicles and more particularly, to a patrol and inspection vehicle.

### 2. Description of the Related Art

In many factories, because of processing requirements, various gases need to be transported through pipelines from place to place. Some of these gases are toxic or flammable; therefore, regular patrols and inspections to check these gases by personnel are required. Normally, the factory occupies a large area, and the pipelines are distributed complex and lengthy, result in that the patrols and inspections are very labor-consuming. In another aspect, some gases are colorless and odorless, such that it is easy for personnel to overlook or misjudge during inspections. Furthermore, some areas in the factory are prohibited from entering, and generally only warning lines are drawn on the ground for warning purpose. If operators or outsiders accidentally enter these restricted areas, there is no warning mechanism. These deficiencies may cause industrial safety problems.

### SUMMARY OF THE INVENTION

The present invention has been accomplished in view of the above-noted circumstances. It is an objective of the present invention to provide a patrol and inspection vehicle, which can automatically inspect whether there are gas leaks in pipelines and detect if individuals have accidentally entered restricted areas.

It is another objective of the present invention to provide a patrol and inspection vehicle, which can reduce the manpower required for patrols and enhance factory safety. To attain the above-mentioned objectives, the present invention provides a patrol and inspection vehicle comprising a vehicle body, a plurality of distance measuring devices, a light detection and ranging (LIDAR) sensor, a panoramic camera, and a gas detector. The distance measuring devices are installed on front and rear sides of the vehicle body for detecting distances of ambient objects. The LIDAR sensor is installed on the vehicle body for constructing a three-dimensional spatial model for positioning and navigation. The panoramic camera is installed on the vehicle body for recognizing images of ambient individuals. The gas detector is installed on the vehicle body for detecting leaked gases having a temperature different from room temperature. As a result, the patrol and inspection vehicle can automatically inspect whether there are gas leaks in the pipelines and detect if individuals have accidentally entered the restricted areas, thereby reducing the manpower required for patrols and enhancing the factory safety.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a patrol and inspection vehicle according to an embodiment of the present invention; and

FIG. 2 is another perspective view of the patrol and inspection vehicle of the embodiment of the present invention.

### DETAILED DESCRIPTION OF THE INVENTION

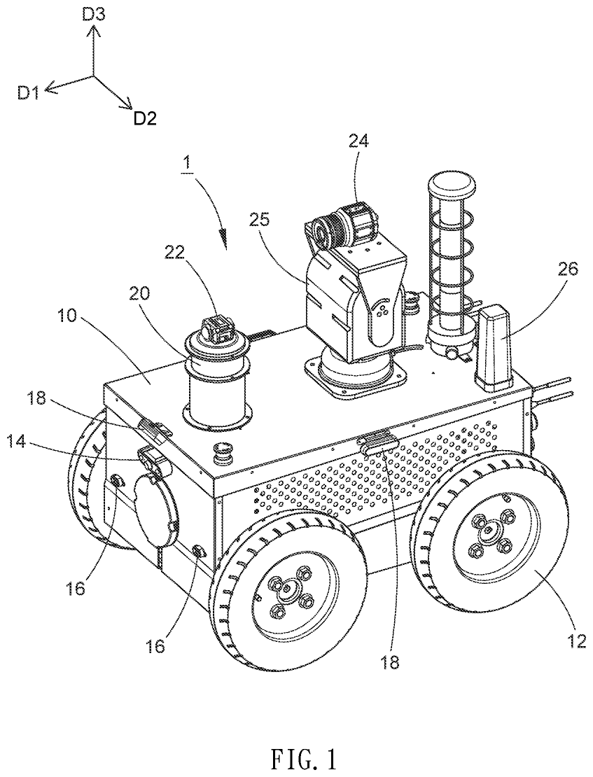

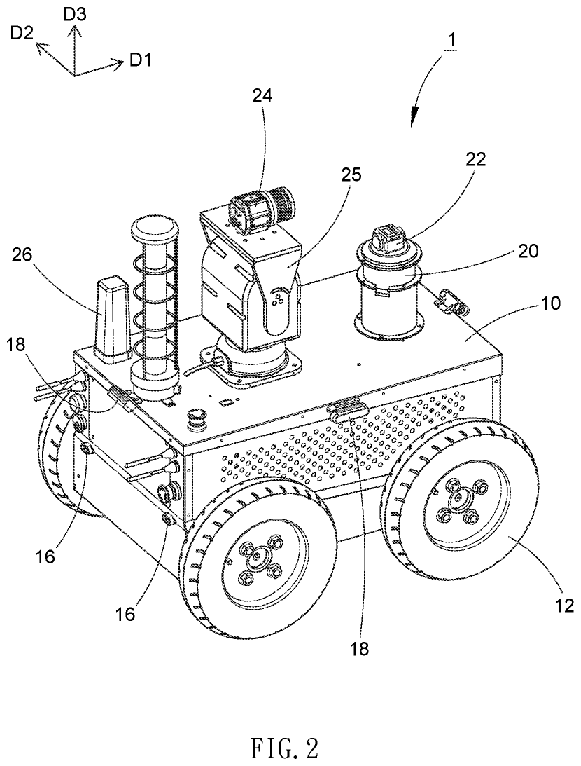

Hereunder an embodiment will be detailedly described with accompanying drawings for illustrating technical features and structure of the present invention. As shown in FIGS. 1-2, a patrol and inspection vehicle 1 provided by an embodiment of the present invention is composed of a vehicle body 10, a first-person view camera 14, four distance measuring devices 16, four depth cameras 18, a light detection and ranging (LiDAR) sensor 20, a panoramic camera 22, a gas detector 24, and an antenna 26. For easy illustration, in this written description, the direction indicated by D1 in FIGS. 1 and 2 is referred to the front direction and the reverse direction thereof is the rear direction, the direction indicated by D2 is referred to the left direction and the reverse direction thereof is the right direction, and the direction indicated by D3 is referred to the top direction and the reverse direction thereof is the bottom direction.

The vehicle body 10 is in the shape of a rectangular cuboid, having two wheels 12 on each of the left and right sides thereof, respectively.

The first-person view camera 14 is positioned on the front side of the vehicle body 10 to capture images of the area in front of the vehicle body 10. These images are used for the observation of the front environment by the operator and for recording purposes.

The distance measuring devices 16 are arranged in paired manner and placed on the front and rear sides of the vehicle body 10 to detect distances of ambient objects surrounding the vehicle body 10. They are used to detect obstacles and provide alerts. To accurately measure distances, a pair of distance measuring devices 16 is placed on the left front and right front of the vehicle body 10, and another pair is placed on the left rear and right rear of the vehicle body 10. These distance measuring devices 16 use ultrasound to measure distances. However, in another embodiments, infrared rangefinders, laser rangefinders, or other types of distance measuring devices may also be used.

The depth cameras 18 are positioned around the vehicle body 10 to acquire depth information about the ambient environment surrounding the vehicle body 10. Specifically, these depth cameras 18 are placed on the front, rear, left, and right sides of the vehicle body 10. They can detect variations of the ground around the vehicle body 10, such as ditches or barriers, such that these depth cameras 18 can be used for obstacle detection and warnings. In another embodiment, these depth cameras 18 may be omitted.

The LiDAR sensor 20 is installed on the vehicle body 10 to construct a three-dimensional spatial model of the ambient surroundings of the vehicle body 10 for positioning and navigation purposes. Before the patrol and inspection vehicle 1 begins its service, the LIDAR sensor 20 collects the surrounding environmental data and creates a model. When the patrol and inspection vehicle 1 starts its navigation service, it compares the point cloud data scanned by the LiDAR sensor 20 at the current time and the previously collected modeling data to determine its position and plan the patrol route in coordination with the vehicle body 10 to achieve navigation functionality.

The panoramic camera 22 is installed on the vehicle body 10 to recognize images of ambient individuals around the vehicle body 10 and, based on the aforementioned positioning information, determine if there are individuals accidentally entering restricted areas. In this embodiment, the panoramic camera 22 is positioned above the LIDAR sensor 20; however, it can also be placed at other suitable locations on the vehicle body 10.

The gas detector 24 is mounted on the vehicle body 10 via a PTZ (Pan-Tilt-Zoom) platform 25 to detect any leaked gases that have a temperature different from room temperature. The PTZ platform 25 has pan, tilt, and zoom functions for remote control of the direction and focus of the gas detector 24. The gas detector 24 is a thermal imaging camera that uses infrared radiation for detection, which is capable of identifying the outlines of gases that have a temperature deviated from room temperature. In this case, the wavelength of the infrared radiation is between 7.5 μm and 14 μm. However, in another embodiment, other wavelength bands of infrared radiation or other types of gas detectors, such as gas composition analyzers, may also be used.

The antenna 26 is installed on the vehicle body 10 to transmit information detected by the first-person view camera 14, the distance measuring devices 16, the depth cameras 18, the LiDAR sensor 20, the panoramic camera 22, and the gas detector 24 back to a remote controller (not shown). It also receives messages from the controller to control the vehicle body 10 and the aforementioned various elements.

Since the temperature of leaked gases is usually different from room temperature, the gas detector 24 (thermal imaging camera) can effectively identify whether there are gas leaks in the pipelines of a factory. After the model is established by the LIDAR sensor 20, the patrol and inspection routes can be planned and the navigation of the patrol and inspection vehicle 1 can starts accordingly. By means of the distance measuring devices 16 and the depth cameras 18, the patrol and inspection vehicle can effectively avoid obstacles. The first-person view camera 14 allows the operator to observe the environment in front of the vehicle body 10 and then adjust the patrol and inspection routes if necessary. With the panoramic camera 22, the patrol and inspection vehicle 1 can recognize if individuals have accidentally entered restricted areas. Through the aforesaid structural features, the patrol and inspection vehicle 1 provided by the present invention can autonomously inspect whether there are gas leaks in the factory's pipelines, reducing the manpower required for patrols and inspections and enhancing the factory safety, thereby achieving the objectives of the present invention.

Based on the above-mentioned technical features, various modifications to the structure of the patrol and inspection vehicle 1 may be made. For example, the PTZ platform may be replaced with other platforms, and the number and types of the distance measuring devices, depth cameras, or gas detectors may be modified. Such variations are not to be regarded as a departure from the scope of the invention, and all such modifications as would be obvious to one skilled in the art are intended to be included within the scope of the following claims.

What is claimed is:

1. A patrol and inspection vehicle, comprising:
a vehicle body;
a plurality of distance measuring devices located on front and rear sides of the vehicle body for detecting distances of ambient objects;
a light detection and ranging (LiDAR) sensor installed on the vehicle body for constructing a three-dimensional spatial model for positioning and navigation;
a panoramic camera installed on the vehicle body for recognizing images of ambient individuals; and
a gas detector installed on the vehicle body for detecting leaked gases having a temperature different from room temperature.

2. The patrol and inspection vehicle as claimed in in claim 1, wherein the gas detector is a thermal imaging camera.

3. The patrol and inspection vehicle as claimed in claim 2, wherein the thermal imaging camera utilizes infrared radiation for detection.

4. The patrol and inspection vehicle as claimed in claim 3, wherein the infrared radiation has a wavelength ranging from 7.5 μm to 14 μm.

5. The patrol and inspection vehicle as claimed in claim 1, wherein the gas detector is installed on the vehicle body by a pan-tilt-zoom (PTZ) platform.

6. The patrol and inspection vehicle as claimed in claim 1, wherein the distance measuring devices utilize ultrasound for distance measurement.

7. The patrol and inspection vehicle as claimed in claim 1, further comprising at least one antenna installed on the vehicle body.

8. The patrol and inspection vehicle as claimed in claim 1, further comprising a plurality of depth cameras positioned around the vehicle body to acquire depth information about ambient environment.

9. The patrol and inspection vehicle as claimed in claim 1, further comprising a first-person view camera mounted on the front side of the vehicle body to capture images of the area in front of the vehicle body.

10. The patrol and inspection vehicle as claimed claim 1, further comprising a plurality of wheels installed on the vehicle body.
